(19) United States
(12) Patent Application Publication
(10) Pub. No.: US 2015/0379654 A1
(43) Pub. Date: Dec. 31, 2015

(54) METHODS AND SYSTEMS FOR DIGITALLY CAPTURING AND MANAGING ATTENDANCE

(71) Applicant: XEROX CORPORATION, Norwalk, CT (US)

(72) Inventors: Om D. Deshmukh, Bangalore (IN); Rinku Gajera, Bangalore (IN)

(21) Appl. No.: 14/315,772

(22) Filed: Jun. 26, 2014

(51) Int. Cl. G06Q 50/20; G06Q 10/10

(52) U.S. Cl. CPC G06Q 50/205; G06Q 10/10

(57) ABSTRACT

An embodiment is directed to an attendance management system having a client device and a server device. The client device includes a first transceiving module for receiving one or more parameters from a host; a display module for displaying one or more modes of interaction for selection to the host, the modes of interaction being an audio interaction mode and a visual interaction mode; and an attendance module for capturing and assigning an attendance to one or more members based on a selection of the at least one of the modes of interaction. The server device includes a second transceiving module for receiving the assigned attendance, and a database for storing and maintaining the assigned attendance and other information. The client device and the server device are configured to communicate with each other over a network.

### TECHNICAL FIELD

The presently disclosed embodiments relate to methods and systems for digitally capturing and managing data, and more particularly, to methods and systems for automatically and digitally capturing and managing attendance of a plurality of members, such as students.

### BACKGROUND

It is relevant in many contexts to determine attendance of members of a group, such as in the case of taking attendance of students in a particular class. In fact, taking attendance of students can be an integral part of lectures of colleges courses, educational institutes, etc. Similarly, attendance may be taken in meetings, conferences, etc., in the context of corporate offices. Determining attendance can be relevant for numerous reasons. For example, in some colleges and institutions, there may be a rule defining a minimum percentage of attendance required for each student to be eligible for appearing for examination or clearing an examination/course.

Typically, attendance is taken in a classroom or a meeting room by verbally inquiring as to whether a certain individual is present, and then recording the individual's name, roll number or identity (ID) based upon whether the individual confirmed his or her presence. Hence, a lot of time of the lecture or the meeting may be consumed solely in taking attendance. Further, a person, such as a lecturer, may have to spend more time in transferring the day's attendance from his/her sheet to a central physical roster or a computerized system. This information is rarely uploaded to the central repository on a daily basis, and instead it is typically performed on a bi-weekly/monthly basis, etc. This manual process is not only time consuming, and the information is not processed on a real-time basis, but it is also error-prone.

### SUMMARY

It may therefore be beneficial to provide better or enhanced techniques for capturing attendance of a group of people/members. Thus, some embodiments provide methods and apparatus for automatically capturing attendance in real-time, such as by using existing IT infrastructure that may be present in current classrooms. These embodiments allow for either a lecturer-driven (application driven) or a student-driven (member driven) attendance, either via an audio interaction or an visual interaction.

In accordance with some embodiments, the lecturer activates the client side application, which can be either a mobile-app or a desktop-app, in the classroom and inputs class-specific details, such as course number and section number. The application populates the names of the students expected in the class, and prompts the lecturer to choose either an audio-driven, visual-driven or a combination approach for role-calling. The client-side application/module allows interruption, re-start, and modify capabilities to mimic real-life scenarios. The server-side application/module then seamlessly integrates the attendance information of the students with further details, such as the students' extracurricular activities, their levels of engagements, disciplinary actions, and academic performance.

This easy access to digitized daily attendance information, coupled with other data, such as the lecturer, topic of the lecture, etc., enables a deeper analysis for identifying patterns in the attendance. For example, this information can indicate which lecturers and/or lectures are more popular, which cluster of students miss classes, and can even help determine remedial measures.

An embodiment is an attendance management system having a client device and a server device. The client device includes a first transceiving module for receiving one or more parameter(s) from a host; a display module for displaying one or more modes of interaction for selection to the host, the one or more modes of interaction being at least one of an audio interaction mode and a visual interaction mode; and an attendance module for capturing and assigning an attendance to one or more members based on a selection of the at least one of the one or more modes of interaction. The server device includes a second transceiving module for receiving the assigned attendance from the client device, the first transceiving module transmits the assigned attendance to the server device, and a database for storing and maintaining the assigned attendance and other information. The client device and the server device are configured to communicate with each other over a network.

Another embodiment is a method for managing attendance. The method includes activating an attendance module on a client device. In an embodiment, a host may activate the attendance module. The method also includes receiving, at the client device, one or more parameters from the host. The method further includes displaying, by the client device, one or more modes of interaction for selection to the host. The one or more modes of interaction is at least one of an audio interaction mode and a visual interaction mode. The host may be prompted to select at least one mode of interaction from the displayed one or more modes of interaction. The method further includes capturing by the attendance module of the client device, an attendance of one or more members based on a selection of at least one mode of interaction. The method also includes sending, by the client device, the captured attendance to a server device. The method further includes storing and maintaining, by the server device, the captured attendance and other information and integrating, by the server device, the captured attendance of the one or more members with the other information.

A further embodiment is a system for digitally capturing attendance of one or more members. The system includes a client device including a first transceiving module for receiving one or more parameters from a host. The client device also includes a display module for displaying one or more modes of interaction for selection to the host. The one or more modes of interaction being at least one of an audio interaction mode and a visual interaction mode. The host may be prompted to select at least one of the one or more modes of interaction. The client device further includes an attendance module for capturing attendance of the one or more members based on a selection of at least one of the one or more modes of interaction.

A yet another embodiment is a method for digitally capturing attendance of one or more members. The method includes activating an attendance module on a client device. A host may activate the attendance module on the client device. The method also includes receiving, at the client device, one or more parameters from the host. The method also includes displaying, at the client device, one or more modes of interaction for selection to the host. The one or more modes of interaction being at least one of an audio interaction mode and a visual interaction mode. The host may be prompted to select at least one of the one or more modes of interaction. The method further includes automatically capturing, by the client device, attendance of the one or more members based on a selection of the at least one of the one or more modes of interaction.

### BRIEF DESCRIPTION OF THE DRAWINGS

FIG. 1 is a schematic that illustrates an exemplary overall system in which various embodiments of the present disclosure may be practiced.

FIG. 2A is a schematic that illustrates system elements of a client device, according to an embodiment of the present disclosure.

FIG. 2B is a schematic that illustrates system elements of a client device, according to another embodiment of the present disclosure.

FIG. 3 is a schematic that illustrates system elements of a server device, according to an embodiment of the present disclosure.

FIGS. 4A-4D are flowcharts illustrating a method for digitally capturing and managing attendance of one or more members, according to an embodiment of the present disclosure.

FIGS. 5A-5F are schematics that illustrate various user interfaces on the client device for capturing the attendance of the one or more members, in accordance with an embodiment of the present disclosure.

### DETAILED DESCRIPTION

The following detailed description is provided with reference to the figures. Exemplary, and in some case preferred, embodiments are described to illustrate the disclosure, not to limit its scope, which is defined by the claims. Those of ordinary skill in the art will recognize a number of equivalent variations in the description that follows.

The present disclosure provides methods and systems for automatically capturing attendance of one or more members such as students, in real-time. The present disclosure also provides methods and systems for digital capturing of attendance. The proposed methods and systems allow for either an application driven or a member/student driven approach for taking attendance, either in an audio mode of interaction or a visual mode of interaction.

In various embodiments of the present disclosure, definitions of one or more terms, which are used in the present disclosure in the context of automatically capturing attendance of one or more members, such as students, in real-time, are provided below.

The term “attendance” as used in the present disclosure is intended to include or otherwise cover the physical disposition of a member of a group in a required location, such as in the case of a student being physically in attendance in a class at the appropriate time. However, attendance is also used herein in a broader sense to also cover functional attendance, such as a member of a group functionally participating in a group activity, such as a group member participating in the activity over the internet, e.g., via a webinar. Attendance is also used herein as a verb, such as to cover the act of taking attendance, both physically and functionally.

The term “insight” as used in the present disclosure is intended to include or otherwise cover any and all useful or otherwise beneficial arrangements, manipulations or usages of the data disclosed herein. For example, insights can be provided to users in the form of reports, including but not limited to: 1) reports including a list of members, such as students whose attendance is less in two or more subjects in the course, or 2) reports including the number of days on which attendance was least or most. However, the term insight is intended to cover any other conclusions, trends, or statistics directly or indirectly relating to any of the data disclosed herein.

The term “approach” as used in the present disclosure is intended to include or otherwise cover any relevant methodology. For example, the disclosed approaches for taking attendance are intended to cover any known, related art or later developed methodologies for taking attendance that are relevant in the context of automatically capturing attendance of one or more members in real-time, including but not limited to the disclosed application driven approach and member driven approach.

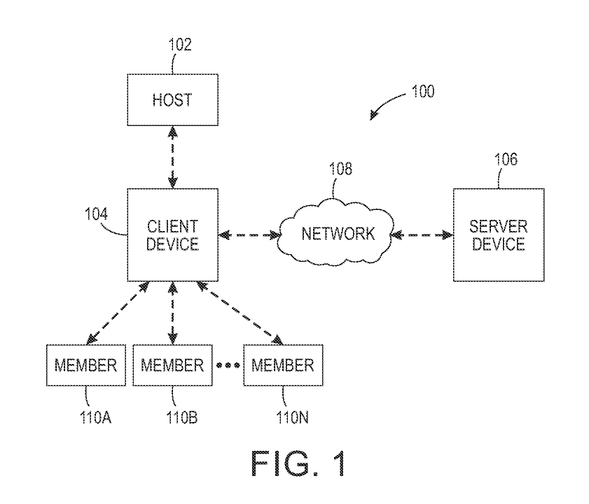

FIG. 1 is a schematic that illustrates an overall exemplary system 100 in which various embodiments of the disclosed embodiments may be practiced. The system 100 includes a client device 104, and a server device 106. The client device 104 can be any suitable computing device, such as, but not limited to, a mobile phone, a smart phone, a desktop computer, a laptop, a tablet computer, a personal digital assistant (PDA), and so forth. The server device 106 can run on a dedicated computer, or may include one or more networked computers or other devices that are configured to process one or more service requests of the client device 104. The system 100 can also include more than one client device 104 and the server device 106, although these additional devices are not shown in the figures.

Further, the client device 104 and the server device 106 are configured to communicate with each other over a network 108. The network 108 can be a wired network, a wireless network, or a combination of wired and wireless networks. The network 108 can be a telecommunication network that enables exchange of information or data between the client device 104 and the server device 106. Examples of the network 108 include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

In some embodiments, the client device 104 and the server device 106 are configured to communicate in real-time. In alternate embodiments, the client device 104 is configured to communicate with the server device 106 in non-real time. As shown, the system 100 also includes a host 102 and a number of members 110A-110N. In an exemplary scenario, the host 102 can be a lecturer, a teacher, or a meeting coordinator. Examples of the one or more members 110A-110N can be, but are not limited to, students or corporate individuals in a class or corporate meeting, respectively. The host 102 can access and interact with the client device 104.

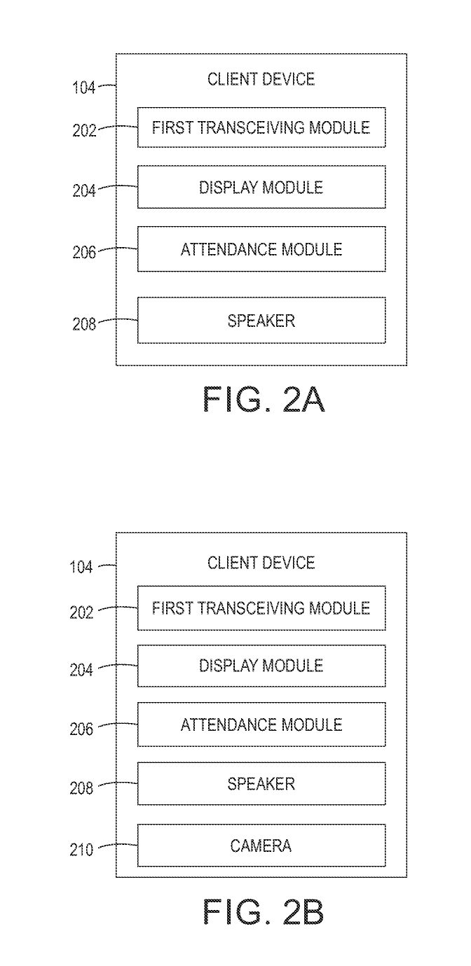

The client device 104 may include a number of modules or applications, which are described in detail with reference to FIGS. 2A-2B. The host 102 can activate an attendance module on the client device 104 to initiate attendance capturing. The term “attendance” as used in the present disclosure is intended to include or otherwise cover the physical disposition of a member of the one or more or members 110A-110N of a group in a required location, such as in the case of a student being physically in attendance in a class at the appropriate time. However, attendance is also used herein in a broader sense to also cover functional attendance, such as a member of a group functionally participating in a group activity, such as a group member participating in the activity over the Internet, for example, via a webinar.

The host 102 may be required to enter one or more personal details or login credentials, such as a login id and/or password, for accessing the attendance module on the client device 104. The host 102 may be authenticated based on the entered login details. The host 102 may be authenticated based on an identity of the client device 104. In some embodiments, the client device 104 authenticates an identity of the host 102. In alternate embodiments, the server device 106 authenticates the identity of the host 102 or the client device 104.

Further, the client device 104 can receive one or more parameters. In some embodiments, the host 102 may enter the one or more parameters at the client device 104. In some embodiments, the host 102 may select the one or more parameters from one or more dropdown menus on a user interface that is shown at the client device 104. Examples of the one or more parameters may include, but are not limited to, class, course or meeting specific details, such as class number/name and course name/number, meeting agenda, subject, and so forth. Based on the one or more parameters the client device 104 can display one or more modes of interaction for selection to the host 102. The one or more modes of interaction may be an audio interaction mode, a visual interaction mode, or a combination of these modes. In some embodiments, the host 102 may be displayed with interaction modes, such as but not limited to, ‘Call-out’, ‘Record’, and ‘Photo’. The host 102 can select at least one of the one or more interaction modes. The client device 104 may then capture attendance of the one or more members 110A-110N based on a selection of the at least one mode of interaction. In some embodiments, the host 102 selects the at least one mode of interaction. In alternate embodiments, any user, such as one of the members 110A-110N, selects the at least one of the one or more modes of interaction. Based on the selection of the mode of interaction, the attendance module may capture an attendance of each of the one or more members 110A-110N. Further, the attendance may indicate physical disposition of a member of the one or more members 110A-110N in a required location. Alternatively, the attendance may indicate functional presence/participation of a member in an activity, for example, the member may participate functionally in a webinar through Internet.

The captured attendance is sent to the server device 106 for further processing. The server device 106 stores, and maintains the captured attendance, responses, and other information. The server device 106 may also integrate the captured attendance of the members 110A-110N with the other information. The other information can be details about members 110A-110N, course(s), syllabus of the subjects, students' lecture centric attendance for each course, and so forth.

The client device 104 is configured to capture attendance in at least one of an application driven approach or a member driven approach when the audio interaction mode is selected. In the application driven approach, a list of the one or more members 110A-110N corresponding to the one or more parameters is loaded and displayed at the client device 104. For example, a list of students may be displayed to the host 102 based on the one or more parameters such as, a course name/number and/or class/section as provided or selected by the host 102. Then, the client device 104 may call out identity information associated with each of the one or more members 110A-110N. In an embodiment, one or more speakers (see 208 in FIG. 2A) associated with the client device 104 are used for calling out the identity information of the one or more members 110A-110N. In an exemplary scenario, the roll number of the one or more members 110A-110N are called out for capturing the attendance. The one or more members 110A-110N may respond as identity information, such as a first name, last name, a roll number, etc., is called out by the client device 104. Accordingly, the responses are recorded for each of the one or more members 110A-110N by the client device 104. The client device 104 can also record each member speaking out his/her name as ‘Om Deshmukh’, ‘Rinku’, ‘Nutter’, and so on. The recorded responses may be sent to the server device 106 for further processing. At the server device 106, the responses may be compared with a pre-stored set of responses. Examples of the pre-stored responses may include, but are not limited to, ‘yes’, ‘present’, ‘yes sir’, ‘present sir’, ‘yes madam’, ‘absent’, ‘present madam’, ‘Rob present’, ‘Om present’, and so forth. The server device 106 recognizes the response by using one or more speech recognition techniques. Post recognition, the response is mapped to one of the expected member of the one or more members 110A-110N. Further, speech recognition verification is performed to verify and identify proxy-attendance and/or imposters by the attendance module.

The client device 104 (or the attendance module) then may assign or capture an attendance to/of each of the one or more members 110A-110N based on the processing of the response by the server device 106. The attendance may be assigned using a pre-defined color and/or symbol. In an embodiment, the server device 106 may assign the attendance to each of the one or more members 110A-110N. In an exemplary scenario, a validated present attendance may be marked in green color, a non-validated present attendance may be marked as orange, and an absent attendance may be marked as red. Further, a member for which attendance is being processed can be marked as black, and a member not yet covered can be marked as grey.

The attendance may be verified by the server device 106 based on one or more pre-defined attributes of the one or more members 110A-110N. The pre-defined attributes can be pre-recorded voice of the one or more members 110A-110N. For example, the voice of the students may be recorded when the students enrolls for a course. An attendance summary may then be generated at the server device 106 based on the verification. The generated attendance summary is then sent to the client device 104, where it is displayed to the host 102.

In a member driven approach (or ‘Record’ option selection), a list of the one or more members 110A-110N is loaded and displayed at the client device 104. The list of the one or more members 110A-110N may be a pre-stored list and is loaded based on the one or more parameters received from the host 102. For example, a list of students is loaded or displayed for a particular course and class as selected or entered by the lecturer (host 102). The client device 104 then may record identity information when at least one of the one or more members 110A-110N speaks out his/her identity. For example, a student may speak out as ‘Rob present’, ‘Rob Flutter present’, and so forth. The client device 104 is configured to record such identity information. The client device 104 and/or the server device 106 may include a speech recognition module for recognizing the recorded response and mapping the recorded response onto at least one of the one or more members 110A-110N based on a pre-stored voice of the one or more members 110-110N. The client device 104 may compare the recorded identity information with at least one of the list of the one or more members 110A-110N or pre-stored information/attributes such as the voice of the one or more members 110A-110N. In an embodiment, the server device 106 may compare the recorded or captured identity information with the at least one of the list of the one or more members 110A-110N or pre-stored attributes, such as, voice of the one or more members 110A-110N. The client device 104 may assign an attendance to at least one of the one or more members 110A-110N based on the comparison with the pre-recorded information by using a pre-defined color/symbol. In some embodiments, the server device 106 may assign/capture the attendance to/of the one or more members 110A-110N based on the comparison with the pre-recorded information. For example, a validated present attendance may be marked in green color, a non-validated present attendance may be marked as orange, an absent attendance may be marked at red, a member for which attendance is being processed can be marked as black, and a member not yet covered can be marked as grey.

In both the application driven approach and the member-driven approach, the client device 104 also displays one or more operating options to the host 102, through which the host 102 is allowed to interrupt, restart, or modify the process of capturing attendance by displaying one of or more operating options for operating to mimic real-life scenarios. The one or more operating options can be ‘Interrupt’, ‘Modify’ and ‘Restart’. For example, the host 102 may change one of the red colored member names to green, or may advance current member's counter backward or forward.

Further, an attendance summary may be generated by the server device 106, and displayed at the client device 104. In an exemplary scenario, the attendance summary is displayed to the host 102 at the end of roll call or identity information calling. The host 102 is also displayed with one or more options such as, but not limited to, ‘accept the attendance summary’, ‘verify or correct the attendance summary’, and ‘re-check for absent members or imposters in the attendance summary’. The host 102 may choose to just accept the attendance summary and start the lecture or meeting, or the host 102 may choose to verify and correct the summary or may check one or more sets of attendance. For example, the host 102 may check a set of imposters marked using a specific color such as, orange and correct if required. The host 102 can review and/or change the attendance of one or more members 110A-110N as displayed in the attendance summary. The audio and/or visual techniques may not always lead to 100% accuracy and the attendance module allows for the expert human, such as the host 102, to override one or more attendance in the attendance summary. The “modify” option may also allow the host 102 to accept or change the attendance of at least one of the one or more members 110A-110N. For example, if some candidate/student is marked as present but with low confidence, i.e., using an ‘orange’ colour, then a lecturer (or the host 102) may look at the class, verify that the candidate/student in question is indeed present in the class, and mark/correct the attendance accordingly. If the candidate/student is not present in the class, the lecturer can override the attendance marked by the attendance module, and may mark the student as absent. This way the host 102 is given a fair chance to correct and make sure the attendance marked for the one or more members 110A-110N is correct to a large extent. Further, a probability or possibility of error in capturing correction is minimised.

In some embodiments, the identity information is called out in the application driven approach by using Text-to-speech (TTS) technology. The TTS speech can be personalized to mimic the host 102, such as a lecturer's intonation. The related art techniques may be used for extracting salient features of a person's voice and using that information to generate synthetic speech that resembles the person's speech characteristics to a certain degree. At the very least, male voice versus female voice can be appropriately chosen based on the identity of the host 102 and the one or more members 110A-110N.

Further, the automatic speech recognition (ASR) of the responses may be provided as follows: in the application driven interaction mode, the server device 106 may define a list of valid inputs for assigning attendance, for example, a list of nine items ‘yes’, ‘present’, ‘present sir’, ‘yes madam’, ‘yes sir’, ‘present madam’, ‘no’, ‘absent’, and ‘unknown’. The ‘unknown’ may be an acceptor for cases where there was no input or when the input was not recognized as any of the above eight responses. In an embodiment, this grammar can be straightforwardly encoded in ASR system or equivalent language model from this list. Further, the list can be changed if a need for adding/removing any of the options is felt at a later time. For example, if the host 102 or the lecturer realizes that members 110A-110N are used to responding as ‘here’ during the roll call and so the host 102 might want that item to be added to the list of valid responses.

In the member driven interaction mode, the ASR grammar may be a list of all the students with partial names as valid inputs. Speaker recognition may happen at the server device 106. The speaker recognition is the process by which audio recording of a member of the one or more members 110A-110N may be analyzed to confirm whether the person is indeed who he/she claims to be. In an embodiment, about 10 seconds of speech from each audio of the members 110A-110N is required to train individual models for speech/speaker recognition. This may translate to about 1-2 sentences and can very easily be captured when the member enrolls for a course or meeting.

In the visual interaction mode, the client device 104 is configured to capture or click one or more images or video(s) of the one or more members 110A-110N. The client device 104 may click images of the one or more members 110A-110N as a group. The images may be clicked by using a suitable image capturing device, such as a camera (see 210 in FIG. 2B), associated with the client device 104. The captured images may be shared with the server device 106 for further processing. The server device 106 may compare the received images/video(s) with at least one pre-stored image or video of the one or more members 110A-110N. The server device 106 then may assign an attendance to at least one of the one or more members 110A-110N based on the comparison of the received captured image(s) or video(s). The attendance may be assigned using a pre-defined color and/or symbol. The attendance is then may be verified at the server device 106 based on the one or more pre-defined attributes associated with the one or more members 110A-110N. The server device 106 then generates an attendance summary including the assigned attendance of the members 110A-110N. The generated attendance summary is then may be transmitted to the client device 104. The attendance summary may be displayed at the client device 104 for further processing by the host 102. The host 102 may interact with the client device 104 and may manually verify and change the at least one attendance in the attendance summary. The human intervention (e.g., by the host 102) for confirming the attendance of the one or more members 110A-110N confirms more accuracy of the captured attendance.

The server device 106 also provides one or more user interfaces through which the host 102 or the administrator is allowed to review the attendance summary and the generated insight reports. The server device 106 generates the one or more insight reports based on the assigned attendance and the other stored information. Examples of the insight reports may include, but are not limited to: 1) a report including a list of members 110A-110N, such as students whose attendance is less in two or more subjects in the course, or 2) a report including the number of days on which attendance was least or most, and so forth. The insight reports may include reports that provide useful arrangements, trends, manipulations, and usages of the attendance data to the host 102. The host 102 or other user may take one or more actions based on the insight reports. Examples of the one or more actions may include, but are not limited to, informing parents of the students whose attendance is less in a course, or identifying the student for extra classes in particular subject. Further, the server device 106 may assign the attendance to the one or more members 110A-110N based on a comparison of the recorded identity information or the received identity information or images with the pre-defined set of valid responses or images/videos, respectively, of the one or more members 110A-110N.

In an embodiment, further processing of the clicked images, video, responses, identity information, speech, and so forth may be performed by the attendance module 206 and the attendance summary is generated accordingly by the attendance module 206.

FIG. 2A is a schematic that illustrates system elements of the client device 104, according to an embodiment of the present disclosure. As shown, the client device 104 includes a first transceiving module 202, a display module 204, an attendance module 206, and at least one speaker 208. These modules 202-208 may interact with each other to perform and accomplish a desired task.

As discussed with reference to FIG. 1, the host 102 can initiate the attendance module 206 on the client device 104. The host 102 can enter one or more login credentials for initiating and accessing the attendance module 206. The server device 106 may authenticate the host 102 based on the login credentials and provide access based on the authentication. The host 102 can enter one or more parameters at the client device 104. The first transceiving module 202 is configured to receive the one or more parameters from the host 102. The attendance module 206 may search for a list of the one or more members 110A-110N based on the received parameters. The display module 204 then may display the list of one or more members 110A-110N to the user. The display module 204 may also display a number of modes of interaction for capturing attendance. The modes of interaction can be at least one of an audio interaction mode, and a visual interaction mode. In audio interaction mode, the host 102 is allowed to initiate capturing of the attendance in either an application driven approach or a member driven approach.

In the application driven approach, the display module 204 displays the list of the one or more members 110A-110N. The at least one speaker 208 calls out identity information of the one or more members 110A-110N. The one or more members 110A-110N may respond as the identity information is called out. The identity information can be a name, a roll number, an identity, and so forth. The first transceiving module 202 may receive and record the responses of the one or more members 110A-110N.

The attendance module 206 is configured to assign the attendance to each of the one or more members 110A-110N. In an embodiment, the attendance may be assigned using a pre-defined color. The attendance of each of the one or more members 110A-110N is verified by the attendance module 206 based on one or more pre-defined attributes associated with the members 110A-110N.

In some embodiments, the first transceiving module 202 may be sent to the server device 106 for further processing. The server device 106 may assign the attendance to the members 110A-110N and generate an attendance summary. The server device 106 may send the attendance summary to the client device 104. The display module 204 may display the attendance summary to the host 102.

In the member driven approach, the attendance module 206 loads the list of the members 110A-110N based on the one or more parameters received from the host 102. The first transceiving module 202 is configured to record identity information when at least one of the one or more members 110A-110N speaks out his/her identity. For example, each of the members 110A-110N may speak out their first name, complete name, roll number, ID, last name, and so forth. In some embodiment, the attendance module 206 may process the recorded identity information and generate the attendance summary. The attendance module 206 may compare the recorded identity information with at least one of the list of the one or more members 110A-110N or pre-stored attribute(s) of the one or more members 110A-110N. In some embodiments, the pre-stored attribute is pre-recorded voice of the one or more members 110A-110N. The attendance module 206 may assign an attendance to at least one of the one or more members 110A-110N based on the comparison using a pre-defined color. The attendance module 206 may further verify the assigned attendance of the one or more members 110A-110N based on the one or more pre-stored attributes. The display module 204 may display the attendance summary to the host 102. The host 102 may further interact with the displayed attendance summary to verify and/or correct one or more attendance of the one or more members 110A-110N as displayed in the attendance summary.

In some embodiments, the recorded identity information is sent to the server device 106 for further processing and attendance summary generation. In this embodiment, the first transceiving module 202 receives the attendance summary from the server device 106 and the display module 204 displays the attendance summary at the client device 104.

In some embodiments, the client device 104 may include a camera 210 as shown in FIG. 2B. Further, the camera 210 may be a part of the client device 104 or may be a separate device connected to the client device 104. The camera 210 is configured to click one or more images or record video(s) of the one or more members 110A-110N.

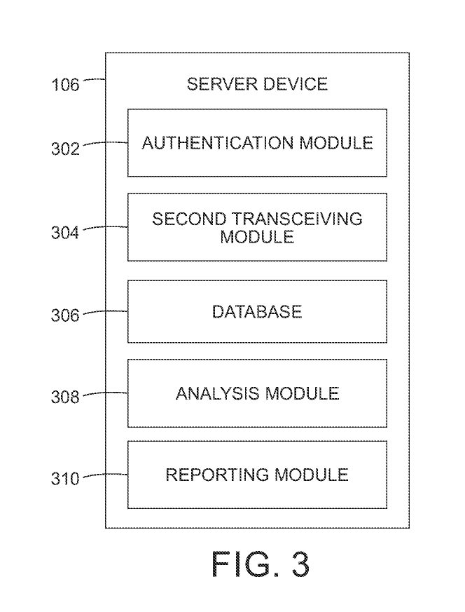

When the host 102 or any other user selects the visual interaction mode (or video mode) for capturing the attendance, the camera 210 may click the one or more images of the members 110A-110N. The one or more images/videos may be sent to the server device 106 for further processing as described with reference to subsequent FIG. 3. The server device 106 may generate an attendance summary and send back to the client device 104. The display module 204 may display the attendance summary at the client device 104.

FIG. 3 is a schematic that will illustrates system elements of the server device 106 of FIG. 1, according to an embodiment of the present disclosure. The server device 106 includes an authentication module 302, a second transceiving module 304, a database 306, an analysis module 308, and a reporting module 310. As discussed with reference to FIGS. 1, 2A, and 2B, the host 102 may select an interaction mode from displayed one or more interaction modes for initiating attendance capturing on the client device 104. The client device 104 is configured to capture/assign attendance using the application driven approach, the member driven approach, and/or visual interaction mode. In the application driven approach, the first transceiving module 202 may send captured responses of the members 110A-110N to the server device 106. In the member driven approach, the client device 104 records identity information as the one or more members 110A-110N speaks out their identity information. The recorded identity information is sent to the server device 106 for further processing. In the visual interaction mode, the client device 104 sends the one or more clicked images or videos to the server device 106 for further processing.

The authentication module 302 is configured to identify the identity of the host 102 based on the login credentials of the host 102 as provided when the host 102 logs in to the client device 104 or based on the identity of the client device 104. The authentication module 302 is also configured to authenticate the client device 104 based on the identity of the client device 104. The authentication module 302 is also configured to authenticate the identity of the one or more members 110A-110N based on identity information of the one or more members 110A-110N.

The second transceiving module 304 is configured to send and receive various information to and from the client device 104. The second transceiving module 304 may receive recorded responses, recorded identity information and clicked images/videos from the client device 104. The second transceiving module 304 is also configured to send attendance summary, insight reports, and other information to the client device 104. The other information may include information about the host 102, the one or more members 110A-110N, the client device 104, and so forth.

The database 306 may store and maintain information about the client device 104, the one or more members 110A-110N, the host 102, and so forth. In an embodiment, the database 306 includes information about various courses and syllabus. The database 306 may remain connected to an exemplary educational resources content and may store syllabus for each course offered by the educational institution/college. Further, the database 306 may include pre-recorded speech or voice of the one or more members 110A-110N, the identity information of the members 110A-110N, the course related information of the one or more members 110A-110N, attendance of the one or more members 110A-110N, and so forth. The attendance information may be used by the analysis module 308 to identify patterns of attendance, engagements, and host 102/topic-affinity.

The analysis module 308 is configured to analyze the received recorded responses, recorded identity information, clicked images, or recorded videos for the members 110A-110N, and so forth. The analysis module 308 is also configured to analyze the attendance pattern for generating various actionable insight reports. The insight reports includes reports that provide useful arrangements, trends, manipulations, and usages of the attendance data to the host 102. Examples of the insight reports may include reports listing members who have been absent for a long period for a particular class or meeting, days with most/least attendance of the one or more members 110A-110N, patterns in attendance of each of the one or more members 110A-110N, and so forth.

The reporting module 310 is configured to provide the host 102 or other users or administrators a user interface through which the host 102 or the users may review the attendance data and the insight reports generated by the analysis module 308. For example, the host 102 may retrieve just in time reports such as, “how many members were absent in previous meeting or lecture”, and so on.

The communication between the server device 106 and the client device 104 can be in real time or may be non-real time, i.e., opportunistic based on the availability of the wireless connectivity.

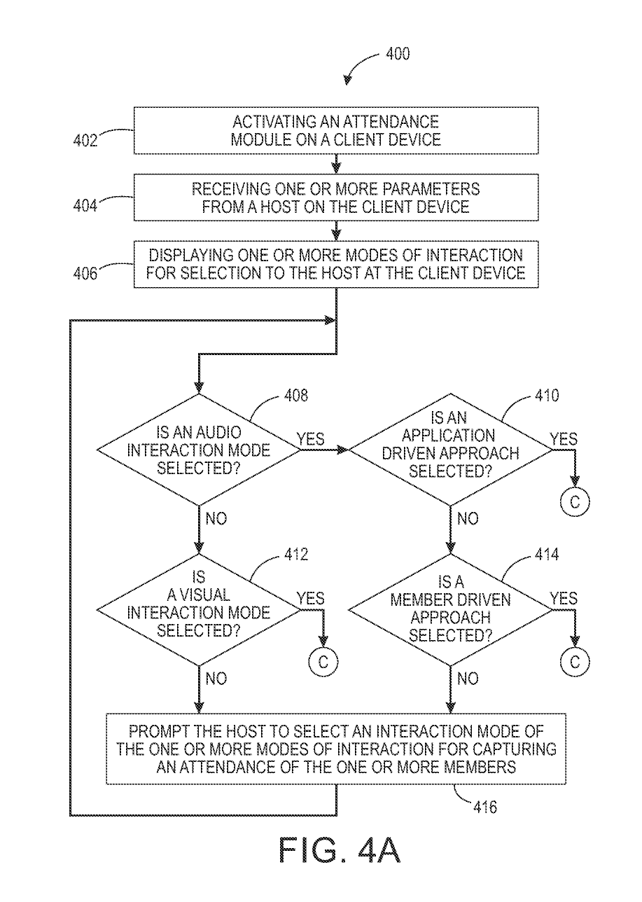

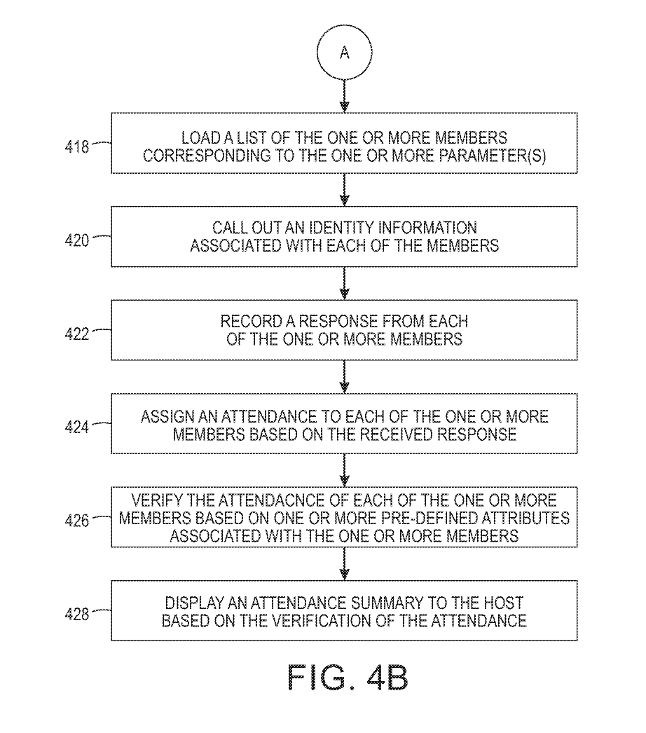

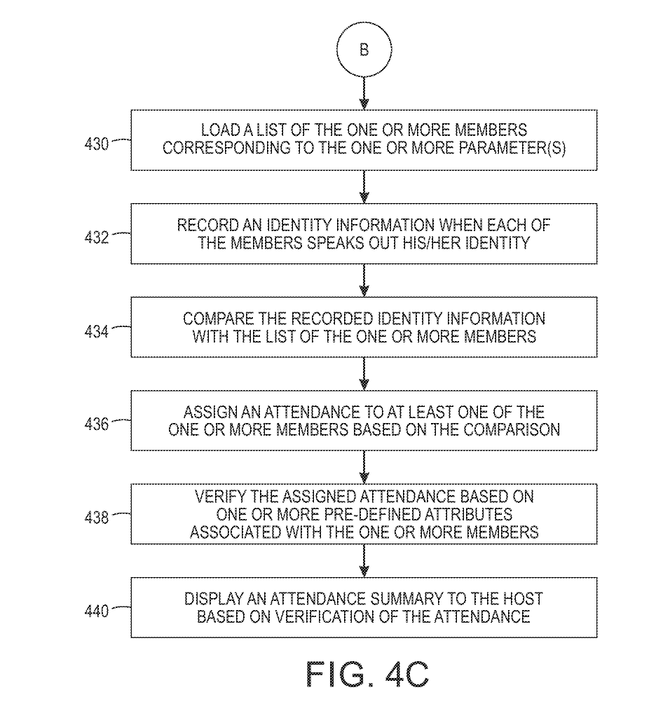

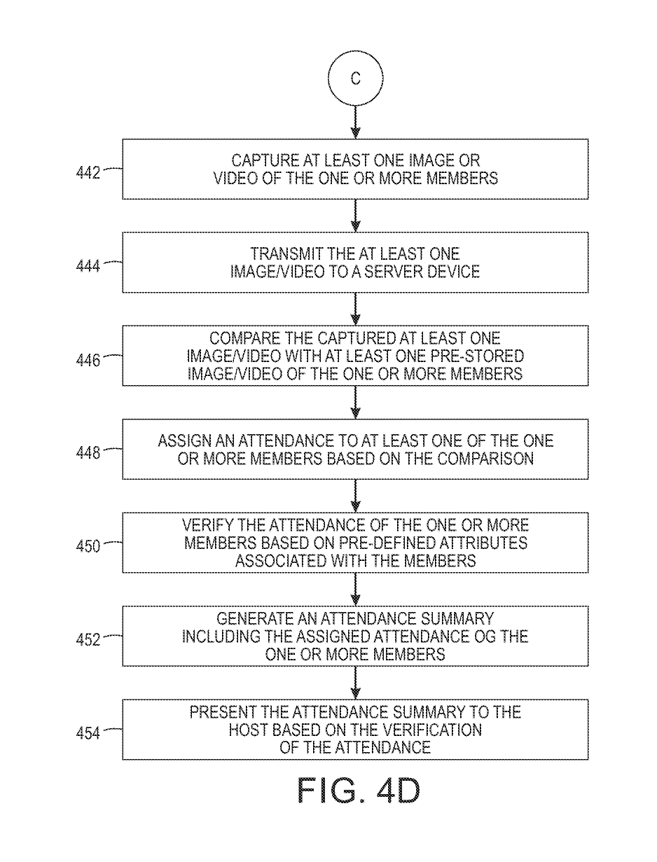

FIGS. 4A-4D are flowcharts illustrating a method 400 for digitally capturing and managing attendance of one or more members 110A-110N, according to an embodiment of the present disclosure. As discussed with reference to FIGS. 1-3, the host 102 can access the client device 104, and various modules 202-210 of the client device 104. The client device 104 and the server device 106 are configured to communicate with each other over the network 108, and exchange data/various reports at various stages for capturing and managing attendance.

At step 402, the attendance module 206 is activated at the client device 104. In an embodiment, the host 102 activates the attendance module on the client device 104 by entering one or more login credentials. The authentication module 203 may authenticate an identity of the host 102 based on the login credentials. In some embodiments, the host 102 may be authenticated based on the ID of the client device 104.

At step 402, the first transceiving module 202 receives one or more parameters from the host 102. The parameters may be information about a course, meeting, class, and so forth. In some embodiments, the host 102 selects the one or more parameters from one or more drop down menus or fields displayed by the display module 204 at the client device 104.

At step 404, the display module 204 may display one or more modes of interaction for selection to the host 102 at the client device 104. The one or more modes of interaction may include an audio interaction mode, and a visual interaction mode. Further, in an audio interaction mode, there are two ways of capturing of attendance, i.e., an application driven approach, and a member driven approach. The host 102 may select the at least one of the displayed modes of interaction.

At step 406, it is checked at the client device 104 whether the audio mode is selected. If yes at step 408, then step 410 is executed, or else step 412 is executed. At step 411, it is checked whether an application driven approach is selected by the host 102. If the application driven approach is selected by the host 102, then step 418 is executed, else step 414 is executed. At step 414, it is checked whether the member driven approach is selected. If the host 102 has selected the member driven approach, then step 430 is executed else control goes to the step 416.

At step 412, it is checked whether the host 102 has selected the visual interaction mode. If the host 102 has selected the visual interaction mode, then step 442 is executed, else step 416 is executed. At step 416, the display module 204 prompts the host 102 to select an interaction mode for capturing an attendance of the one or more members 110A-110N. After step 416, the control goes back to step 408.

At step 418, the attendance module 206 may load a list of the one or more members 110A-110N corresponding to the one or more parameters. The display module 204 may display the list of the one or more members 110A-110N on the client device 104. Then at step 420, the speaker 208 may call out an identity information associated with each of the one or more members 110A-110N. Examples of the identity information may include, but are not limited to, a roll number, an ID, a first name, a last name, a complete name, and so forth. The one or more members 110A-110N may respond as the names are called out by the speaker 208. Examples of the response of the one or more members 110A-110N may include, but are not limited to, ‘present’, ‘absent’, ‘present sir’, ‘absent sir’, ‘absent madam’, ‘present madam, ‘unknown’, and so forth.

At step 422, the client device 104 may record the response of each of the one or more members 110A-110N. In an embodiment, the first transceiving module 202 may receive and record the responses of the one or more members 110A-110N. The recorded responses are sent to the server device 106 for further processing. In an embodiment, the second transceiving module 304 may receive the responses from the first transceiving module 202 of the client device 104. The analysis module 308 may analyze the received responses by comparing the responses with the pre-stored one or more attributes of the one or more members 110A-110N. The one or more attributes can be pre-stored speech or voice of the one or more members 110A-110N. The analysis module 308 then may generate an attendance summary based on the comparison and analysis and assigns the attendance to the one or more members 110A-110N at step 424. The attendance may be assigned using a pre-defined color. Further, the attendance may be verified based on the one or more pre-defined or pre-stored attributes at the server device 106. The analysis module 308 may use speech recognition or text recognition techniques for analyzing the responses and speech of including the identity information of the one or more members 110A-110N. Further, the attendance may indicate physical disposition of a member of the one or more members 110A-110N in a required location. Alternatively, the attendance may indicate functional presence/participation of a member in an activity, for example, the member may participate functionally in a webinar through Internet.

Then, the server device 106 may send the generated and verified attendance summary to the client device 104. Further, the second transceiving module 304 sends the attendance summary to the first transceiving module 202.

At step 428, the attendance summary is displayed to the host 102 on the client device 104 based on the verification of the attendance. Further, the display module 204 may display the attendance summary on the client device 104. In an embodiment, one or more options for allowing the host 102 to perform one or more actions such as, verify the summary, accept the summary, correct the summary, and so forth, may also be displayed at the client device 104.

At step 414, when the member driven approach is selected, then step 430 is executed. At step 430, the attendance module 206 loads a list of the one or more members 110A-110N corresponding to the one or more parameters. Then at step 432, an identity information is recorded when each of the members 110A-110N speaks out his/her identity. For example, the members 110A-110N may speak out ‘Om present’, ‘Rob present’, ‘Rinku Absent’, and so forth. The first transceiving module 202 may send the recorded identity information to the server device 106 for further processing.

Then at step 434, the analysis module 308 may compare the recorded identity information with the list of one or more members 110A-110N or other pre-stored attributes such as pre-stored speech of the one or more members 110A-110N. Further, at step 436, the analysis module 308 may assign an attendance based on the one or more pre-defined attributes of the one or more members 110A-110N. In an embodiment, the attendance module 206 may analyze the recorded identity information and compare the identity information with the pre-stored attributes. Further, the analysis may include automatic speech recognition or text recognition of the recorded identity information based on the pre-recorded speech of the one or more members 110A-110N.

At step 436, an attendance is assigned to at least one of the one or more members 110A-110N based on the comparison. In an embodiment, the analysis module 308 may assign the attendance. In an alternate embodiment, the attendance module 206 may assign the attendance.

At step 438, the assigned attendance is verified based on the one or more pre-stored attributes of the one or more members 110A-110N. In some embodiments, the analysis module 308 may generate an attendance summary based on the verification and is sent to the client device 104 by the second transceiving module 304. In alternate embodiments, the attendance module 206 may generate an attendance summary based on the verification. Thereafter, at step 440, the attendance summary is displayed to the host 102 at the client device 104.

If at step 412, the visual interaction mode is selected, then step 442 is executed. At step 442, at least one image or video of the one or more members 110A-110N is captured using an associated image or video capturing device, such as the camera 210, at the client device 104. In an embodiment, a combination of image and video is captured by the camera 210. Then at step 444, the at least one image or video is transmitted to the server device 106. At step 446, the at least one image/video is compared with at least one pre-stored image/video of the one or more members 110A-110N. In an embodiment, the analysis module 308 may compare the at least one image with pre-stored image of the one or more members 110A-110N.

At step 448, an attendance is assigned to at least one of the one or more members 110A-110N based on the comparison. In an embodiment, the analysis module 308 assigns the attendance. In an alternate embodiment, the attendance module 206 assigns the attendance to the one or more members 110A-110N. At step 450, the attendance is verified based on the one or more pre-defined or pre-stored attributes of the one or more members 110A-110N. In an embodiment, the analysis module 308 verifies the attendance. In an alternate embodiment, the attendance module 206 verifies the attendance.

Thereafter, at step 452, an attendance summary including the assigned attendance of the one or more members 110A-110N is generated. In an embodiment, the analysis module 308 generates the attendance summary and is sent to the client device 104. In an alternate embodiment, the attendance module 206 generates the attendance summary. At step 454, the attendance summary is displayed to the host 102 on the client device 104. Further, the display module 204 may display the attendance summary on the client device 104. In an embodiment, one or more options for allowing the host 102 to perform one or more actions such as, verify the attendance summary, accept the attendance summary, correct the summary, and so forth, may also be displayed at the client device 104.

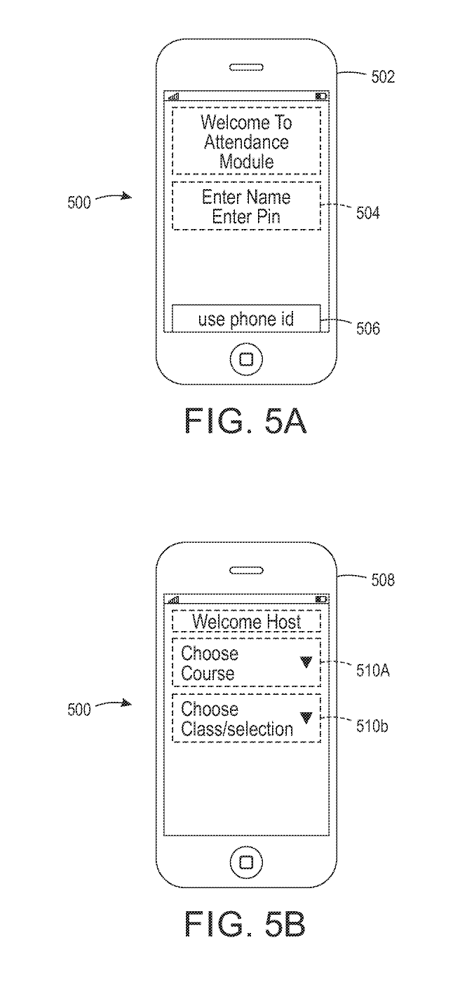

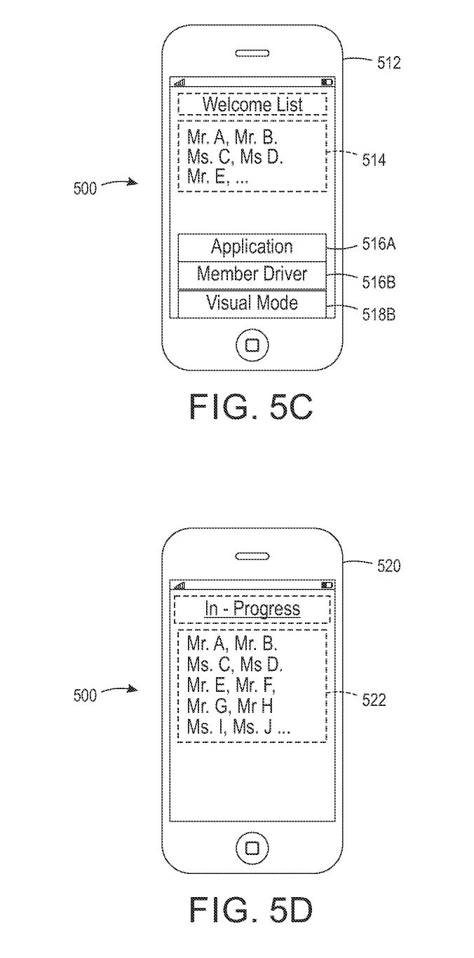

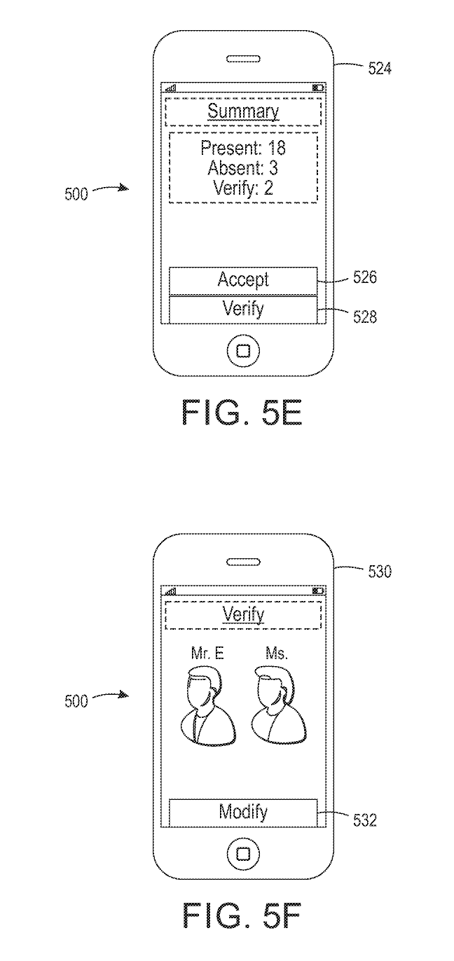

FIG. 5 is a schematic that illustrates various user interfaces on an exemplary client device for capturing the attendance of the one or more members, in accordance with an embodiment of the present disclosure. As shown, the client device can be a mobile phone 500. As discussed with reference to FIG. 1, the host 102 can activate the attendance module 206 for capturing the attendance on the mobile phone 500. The attendance module 206 may be a software or a hardware or combination of these at the mobile phone 500. In an alternate embodiment, the attendance module 206 may be located on any device in the network 108 and may be accessed over the network 108. As shown, the mobile phone 500 may include a user interface 502 including a number of fields 504, or at least one tab 506, where the host 102 can enter his/her login credential such as name, pin, password and so forth. The at least one tab 506 may also be displayed to use the phone id for authentication.

A user interface 508 is displayed to the host 102 post authentication of the host 102 based on entered login credentials or phone ID. One or more parameter fields 510A-510B are displayed, where user either can select from top down menus or enter one or more parameters such as, course, class/section, and so forth.

A user interface 512 is displayed on the mobile phone 500 post receiving or selection the one or more parameters from the host 102. The user interface 512 may display a list 514 including identity information of the one or more members 110A-110N. Further, the user interface 512 may include a number of tabs displaying one or more modes of interaction. The modes of interaction may be a call out mode 516A (application driven approach), a record mode 516B (member driven mode), and a photo or video mode 518 (visual interaction mode). The host 102 can select at least one of the modes 516A-516B and 518.

A user interface 520 is displayed based on the selection by the host 102. The user interface 520 displays a list of members 110A-110N showing the process of attendance being captured using a color coding. For example, a validated present attendance may be marked in green color, a non-validated present attendance may be marked as orange, an absent attendance may be marked at red, a member for which attendance is being processed can be marked as black, and a member not yet covered can be marked as grey.

Then, an attendance summary 526 is displayed to the host 102 at a user interface 524. Further, one or more options 528 such as verify, accept etc. are displayed to the host 102. Based on selection of an option by the host 102, a user interface 530 is displayed. For example, if the host 102 selects the verify option 528, then a modify option 532 is displayed. The host 102 can further modify attendance of at least one of the one or more members 110A-110N. For example, the host 102 may check a set of imposters marked using a specific color such as, orange and correct/modify their attendance, if required. The host 102 can review and/or modify the attendance of at least one of the one or more members 110A-110N.

Exemplary embodiments are intended to cover all software or computer programs capable of performing the various heretofore-disclosed determinations, calculations, etc., for the disclosed purposes, such as via a processor. For example, exemplary embodiments are intended to cover all software or computer programs capable of enabling processors to implement the disclosed processes. In other words, exemplary embodiments are intended to cover all systems and processes that configure a document operating system to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

The above disclosures are merely provided for exemplary purposes. Changes may be made in details, particularly in matters of shape, size, and arrangement of steps without exceeding the scope of the invention. This may include, to the extent that it is appropriate, the use of any of the features of one example embodiment being used in other embodiments. The invention's scope is, of course, defined in the language in which the appended claims are expressed.

What is claimed is:

1. An attendance management system, comprising:
a client device that includes:
a first transceiving module configured to receive one or more parameters from a host;
a display module configured to display one or more modes of interaction for selection to the host, the one or more modes of interaction being at least one of an audio interaction mode and a visual interaction mode, wherein the host is prompted to select at least one of the one or more modes of interaction; and
an attendance module configured to capture and assign an attendance of one or more members based on a selection of the at least one of the one or more modes of interaction, the attendance indicates physical disposition of a member of the one or more members in a required location; and
a server device that includes:
a second transceiving module configured to receive the assigned attendance from the client device, wherein the first transceiving module transmits the assigned attendance to the server device; and
a database configured to store and maintain the assigned attendance and other information;
wherein the client device and the server device are configured to communicate with each other over a network.

2. The attendance management system of claim 1, wherein attendance is functional attendance of the one or more members to indicate their functional participation in a group activity.

3. The attendance management system of claim 1, wherein when the audio interaction mode is selected, the attendance module is configured to capture the attendance of the one or more members in at least one of an application driven approach or a member driven approach.

4. The attendance management system of claim 2, wherein when the application driven approach is selected, the attendance module is configured to perform the following steps:
load a list of the one or more members corresponding to the one or more parameters received from the host;
call out an identity information associated with each of the one or more members;
record a response from each of the one or more members, wherein the first transceiving module receives the response from the one or more members;
assign an attendance to each of the one or more members based on the received response, wherein the attendance is assigned by using a pre-defined color;
verify the attendance of each of the one or more members based on one or more pre-defined attributes associated with the one or more members;
generate an attendance summary based on the verification of the assigned attendance; and
display the attendance summary to the host.

5. The attendance management system of claim 2, wherein when the member driven approach is selected, the attendance module is further configured to perform the following steps:
load a list of the one or more members based on the one or more parameters received from the host;
record an identity information when each of the one or more members speaks out his/her identity;
compare the recorded identity information with the list of the one or more members;
assign an attendance to at least one of the one or more members based on the comparison, wherein the attendance is assigned by using a pre-defined color;
verify the assigned attendance of the one or more members based on one or more pre-defined attributes associated with the one or more members;
generate an attendance summary based on the verification of the assigned attendance; and
display the attendance summary to the host.

6. The attendance management system of claim 1, wherein, when the visual interaction mode is selected, the attendance module is configured to process at least one image of the one or more members, the at least one image is captured using a camera associated with the client device.

7. The attendance management system of claim 5, wherein the first transceiving module is further configured to transmit the at least one image to the server device.

8. The attendance management system of claims 2, wherein the server device further comprises:
an analysis module configured to:
integrate the captured attendance of the one or more members with the other information;
analyze the received attendance to generate one or more actionable insight report;
compare the received at least one image with at least one pre-stored image of the one or more members;
assign an attendance to at least one of the one or more members based on the comparison, wherein the attendance is assigned by using a pre-defined color;
verify the assigned attendance of the one or more members based on one or more pre-defined attributes associated with the one or more members;
generate an attendance summary including the assigned attendance of the one or more members; and
a reporting module configured to provide a user interface to use or review the attendance data and the generated insight reports, wherein the insight reports comprises reports that provide useful arrangements, trends, manipulations, and usages of the attendance data to the host.

9. The attendance management system of claim 7, wherein the attendance is assigned by comparing the recorded identity information or the received identity information with at least one of a pre-defined set of valid responses and the at least one pre-stored image of the one or more members.

10. The attendance management system of claim 8, wherein the second transceiving module is further configured to send the generated attendance summary and the insight reports to the client device, wherein the display module displays the attendance summary and the insight reports received from the server device.

11. The attendance management system of claim 9, wherein the display module is configured to allow the host to perform at least one of the following actions:
accept the attendance summary;
verify and correcting the attendance summary; and
check the status of the one or more members assigned as absent and imposter.

12. The attendance management system of claim 1, wherein the attendance module is configured to allow the host to change a processing mode, wherein the processing mode is at least one of an interrupt, restart, and modify.

13. The attendance management system of claim 1, wherein the client device and the server device are configured to communicate with each other in real time via the network.

14. A method for managing attendance, comprising:
activating an attendance module on a client device;
receiving, by the client device, one or more parameters from a host;
displaying, by the client device, one or more modes of interaction for selection to the host, the one or more modes of interaction being at least one of an audio interaction mode and a visual interaction mode, wherein the host is prompted to select at least one of the one or more modes of interaction;
capturing, by the attendance module of the client device, an attendance of one or more members based on a selection of at least one mode of interaction, the attendance indicates physical disposition of a member of the one or more members in a required location;
sending, by the client device, the captured attendance to a server device;
storing and maintaining, by the server device, the captured attendance and other information; and
integrating, by the server device, the captured attendance of the one or more members with the other information.

15. The method of claim 13, wherein capturing the attendance of the one or more members further comprises capturing the attendance of the one or more members in at least one of an application driven approach or member driven approach when the audio interaction mode is selected.

16. The method of claim 14, further comprising performing the following steps when the application driven approach is selected:
loading a list of the one or more members corresponding to the one or more parameters received from the host;
calling out identity information associated with each of the one or more members;
recording a response for each of the one or more members, wherein the first transceiving module receives the response from the one or more members;
assigning an attendance to each of the one or more members based on the received response, wherein the attendance is assigned by using a pre-defined color;
verifying the attendance of each of the one or more members based on one or more pre-defined attributes associated with the one or more members;
generating an attendance summary based on the verification of the assigned attendance; and
displaying the attendance summary to the host.

17. The method of claim 14, further comprising performing the following steps when the member driven approach is selected:
loading a list of the one or more members based on the one or more parameters received from the host;
recording identity information when at least one of the one or more members speaks out his/her identity;
comparing the recorded identity information with at least one of the list of the one or more members or pre-stored attributes of the one or more members;
assigning an attendance to at least one of the one or more members based on the comparison, wherein the attendance is assigned by using a pre-defined color;
verifying the assigned attendance of the one or more members based on the one or more pre-stored attributes;
generating an attendance summary based on the verification of the assigned attendance; and
displaying the attendance summary to the host.

18. The method of claims 14, wherein the attendance is assigned by comparing the recorded identity information or the received identity information with a pre-defined set of valid responses.

19. The method of claims 14, wherein the attendance is assigned based on a comparison of the recorded identity information or the received identity information with pre-stored identity information.

20. The method of claim 15, further comprising processing at least one image of the one or more members when the visual interaction mode is selected, wherein the at least one image is captured using a camera associated with the client device.

21. The method of claims 14, further comprising performing following steps at the server device:
comparing the received at least one captured image with at least one pre-stored image of the one or more members;
assigning an attendance to at least one of the one or more members based on the comparison of the received at least one captured image, wherein the attendance is assigned by using a pre-defined color;
verifying the assigned attendance of the one or more members based on one or more pre-defined attributes associated with the one or more members;
generating an attendance summary including the assigned attendance of the one or more members; and
providing a user interface through which the host or administrator is allowed to use the attendance summary and the generated insight reports, wherein the insight reports comprises reports that provide useful arrangements, trends, manipulations, and usages of the attendance data to the host.

22. The method of claim 20, further comprising performing following steps at the server device:
generating one or more insight reports based on the analysis; and
sending the generated attendance summary and one or more insight reports to the client device.

23. The method of claims 21, wherein the attendance is assigned by comparing the recorded identity information or the received identity information with a pre-defined set of valid responses and images.

24. The method of claim 13, further comprising transmitting, by the client device, at least one image to the server device.

25. The method of claim 14, further comprising allowing the host to perform at least one of the following actions:
accepting the attendance summary;
verifying and correcting the attendance summary; and
checking the status of the one or more members assigned as absent and imposter.

26. A system for digitally capturing attendance of one or more members, the system comprising:
a client device including:
a first transceiving module configured to receive one or more parameters from a host;
a display module configured to display one or more modes of interaction for selection to the host, the one or more modes of interaction being at least one of an audio interaction mode, and a visual interaction mode, wherein the host is prompted to select at least one of the one or more modes of interaction; and
an attendance module configured to capture attendance of the one or more members based on a selection of at least one of the one or more modes of interaction, wherein the attendance indicates physical disposition of a member of the one or more members in a required location.

27. The system of claim 25, wherein when the audio interaction mode is selected the attendance module is configured to capture the attendance of the one or more members in at least one of an application driven approach or a member driven approach.

28. The system of claim 26, wherein when the application driven approach is selected, the attendance module is configured to perform following steps:
load a list of the one or more members corresponding to the one or more parameters received from the host;
call out an identity information associated with each of the one or more members;
record a response from each of the one or more members, wherein the first transceiving module receives the response from the one or more members;
assign an attendance to each of the one or more members based on the received response, wherein the attendance is assigned by using a pre-defined color;
verify the attendance of each of the one or more members based on one or more pre-defined attributes associated with the one or more members; and
display an attendance summary based on the verification of the attendance to the host.

29. The system of claim 26, wherein when the member driven approach is selected, the attendance module is further configured to perform following steps:
load a list of the one or more members based on the one or more parameters;
record an identity information when each of the one or more members speaks out his/her identity;
compare the recorded identity information with the list of the one or more members;
assign an attendance to at least one of the one or more members based on the comparison, wherein the attendance is assigned by using a pre-defined color;
verify the assigned attendance of the one or more members based on one or more pre-defined attributes associated with the one or more members; and
display an attendance summary based on verification of the attendance to the host.

30. The system of claims 26, wherein the attendance is assigned by comparing the recorded identity or the received identity information or the received identity information with at least one of a pre-defined set of valid responses and images.

31. The system of claim 26, wherein when the visual interaction mode is selected, the attendance module is configured to receive and process at least one image of the one or more members, the at least one image is clicked by an image capturing device associated with the client device.

32. The system of claim 30, wherein the first transceiving module is further configured to transmit the at least one image to the server device.
